(19) United States
(12) Patent Application Publication
(10) Pub. No.: US 2010/0188041 A1
(43) Pub. Date: Jul. 29, 2010

(54) APPARATUS SUPPLYING ELECTRIC POWER TO EXTERNAL DEVICE

(75) Inventor: Yoshihiro Mizuo, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/694,057

(22) Filed: Jan. 26, 2010

(30) Foreign Application Priority Data
Jan. 29, 2009 (JP) 2009-018278

(51) Int. Cl. H02J 7/00

(52) U.S. Cl. 320/108

(57) ABSTRACT

An apparatus includes: a plurality of power supplying units configured to supply electric power to external devices with a battery in a non-contact manner; an acquisition unit configured to acquire information about a power receiving state, the information indicating whether the plurality of external devices receive electric power; and an identification unit configured to identify the external devices to which the plurality of power supplying units supply electric power based on the information about the acquired power receiving state.

### BACKGROUND OF THE INVENTION

1. Field of the Invention

The present invention relates to an apparatus for supplying electric power.

2. Description of the Related Art

As an apparatus for supplying electric power to an external device, there has been known a charging apparatus using electromagnetic induction to charge the external device in a non-contact manner. The non-contact charging apparatus performs charging using a mechanism in which a voltage applied to a primary coil of the charging apparatus is changed (excited) to change magnetic flux around a secondary coil of a charge target device, causing the secondary coil to generate electromotive force (refer to Japanese Patent Application Laid-Open No. 10-233235, for example).

Such a non-contact charging apparatus is chiefly used to charge a device such as an electric shaver and an electric tooth brush which can get wet.

Unlike a conventional charging method, the non-contact charging method eliminates the step for bringing terminals into contact or connecting the charge target device through a cable. For this reason, the non-contact charging method is proposed in various types of devices.

If various types of devices can be charged in a non-contact manner as described above, a system is conceivable in which a single charging apparatus becomes equipped with a plurality of primary coils to simultaneously charge a plurality of devices.

If the plurality of devices is simultaneously charged in a non-contact manner, each primary coil simultaneously charges different devices. If batteries used and characteristics of a circuit are different between the devices, it is important to identify the charge target device for the primary coil to supply an appropriate electric power to the device.

### SUMMARY OF THE INVENTION

One of the aspects of the present invention provides an apparatus which comprises a plurality of power supply units configured to supply electric power to external devices with a battery in a non-contact manner, an acquisition unit configured to acquire information about a power receiving state, the information indicating whether the plurality of external devices receive electric power, and an identification unit configured to identify an external device to which the plurality of power supplying units supply electric power based on the acquired information.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a charging system according to an exemplary embodiment of the present invention.

FIG. 2A is a block diagram illustrating a configuration of a charging apparatus.

FIG. 2B is a block diagram illustrating a configuration of a charge target device.

FIG. 3 is a flow chart indicating the processing for identifying a charge target device.

FIG. 4 illustrates a charging system according to an exemplary embodiment of the present invention.

FIG. 5 is a flow chart indicating the processing for identifying a charge target device.

FIG. 6 is a flow chart indicating the processing for identifying a charge target device.

FIG. 7 illustrates pattern signals.

FIG. 8 illustrates pattern signals.

FIG. 9A is a block diagram illustrating a configuration of a charging apparatus.

FIG. 9B is a block diagram illustrating a configuration of a charge target device.

FIG. 10 is a flow chart indicating the processing for identifying a charge target device.

FIG. 11 is a block diagram illustrating a configuration of a charge target device.

FIG. 12 is a flow chart indicating the processing for identifying a charge target device.

FIG. 13 illustrates a charging system according to an exemplary embodiment of the present invention.

FIG. 14 is a block diagram illustrating a configuration of a charging apparatus and a charge target device.

FIG. 15 is a flow chart indicating the processing for identifying a charge target device.

FIG. 16 illustrates a charging system according to an exemplary embodiment of the present invention.

FIG. 17 is a block diagram illustrating a configuration of a charging apparatus.

FIG. 18 illustrates a display screen of the charging apparatus.

FIG. 19 is a flow chart indicating the operation of the charging apparatus.

### DESCRIPTION OF THE EMBODIMENTS

Various exemplary embodiments, features, and aspects of the invention will be described in detail below with reference to the drawings.

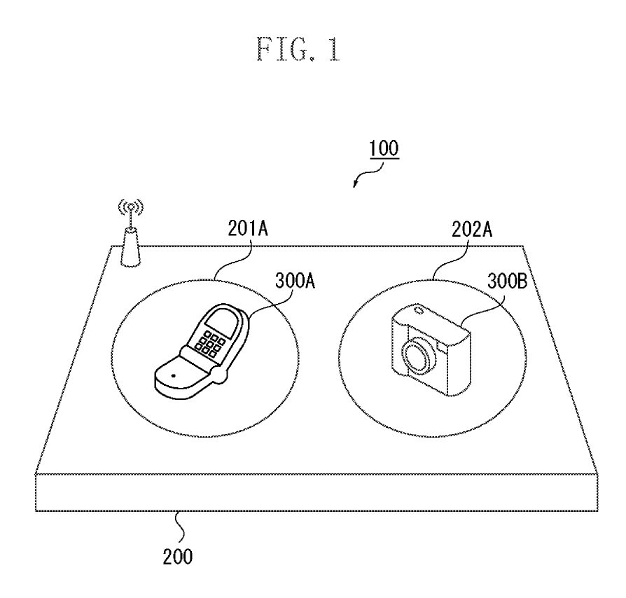

FIG. 1 illustrates a configuration of a charging system 100 according to a first exemplary embodiment of the present invention. The charging system 100 includes a charging apparatus 200 and a charge target device 300. The charging apparatus 200 uses electromagnetic induction to supply electric power to the charge target device 300 in a non-contact manner. The charge target device 300 is an external device with a battery and receives electric power supplied by the charging apparatus 200 to charge the battery. The charging apparatus 200 is in a plate shape and the charge target device 300 can be placed on the charging apparatus 200. The charging apparatus 200 incorporates a coil for supplying electric power in a non-contact manner to charge the charge target device 300. The charge target devices 300 are placed on charging units 201A and 202A which correspond to the coils incorporated in the charging apparatus 200 to enable charging of the batteries incorporated in the charge target devices 300.

FIG. 1 illustrates a cellular phone 300A and a digital camera 300B as the charge target device 300, the present invention, however, is applicable to other devices communicable with the charging apparatus 200 as described later.

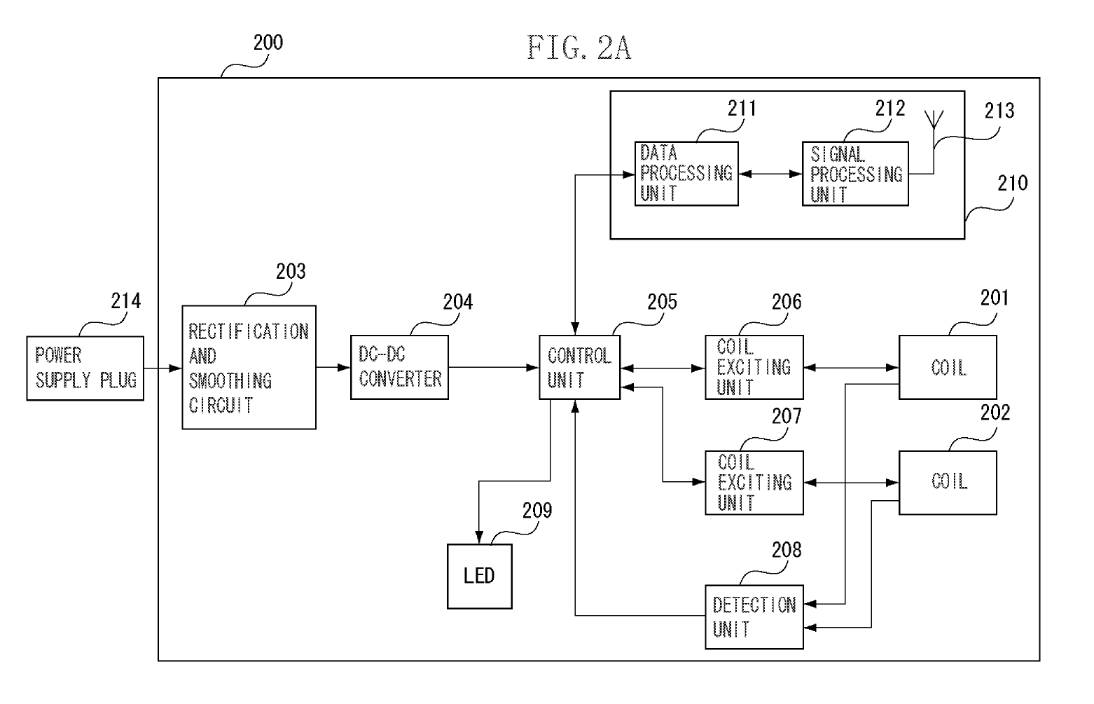

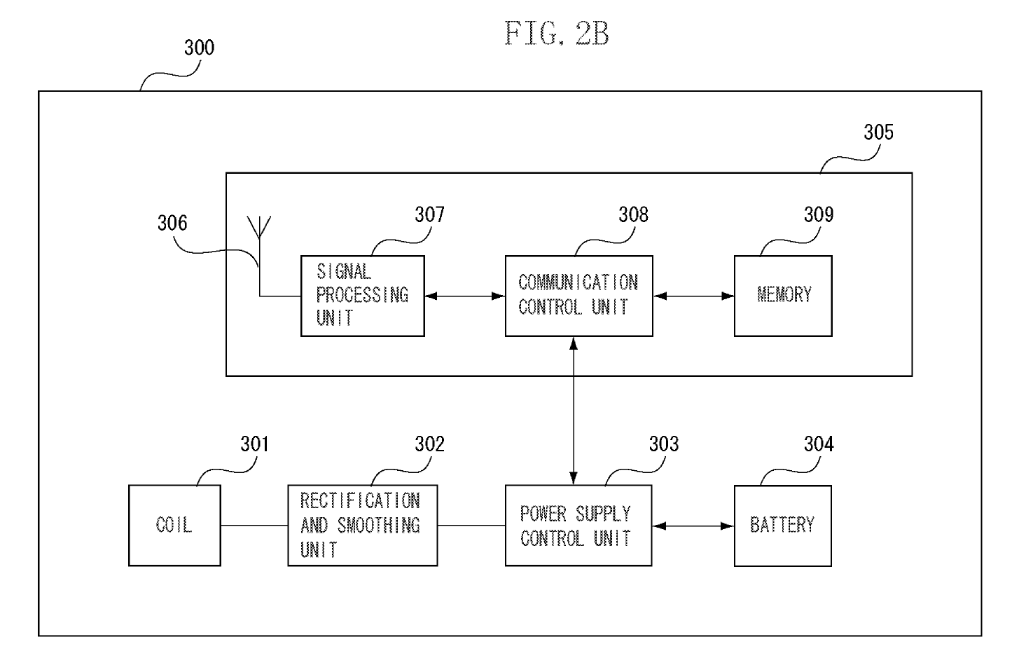

FIG. 2A is a block diagram illustrating a configuration of the charging apparatus 200. FIG. 2B is a block diagram illustrating a configuration of the charge target device 300.

A power supply plug 214 in the charging apparatus 200 is connected to a wall socket to supply AC voltage to a rectification and smoothing circuit 203. The rectification and smoothing circuit 203 rectifies and smoothes the supplied AC voltage to convert it to DC voltage and supplies the DC voltage to a DC-DC converter 204. The DC-DC converter 204 converts the input DC voltage to a predetermined voltage and sends it to a control unit 205. The control unit 205 includes a microcomputer and a memory, and controls each unit in the charging apparatus 200. The control unit 205 controls coil exciting units 206 and 207 to excite coils 201 and 202 using the DC voltage sent from the DC-DC converter 204. The coil exciting units 206 and 207 excite the coils 201 and 202 based on the DC voltage supplied from the DC-DC converter 204 through the control unit 205 to change magnetic flux, supplying electric power to the charge target device 300 in a non-contact manner.

The control unit 205 controls the coil exciting units 206 and 207 to excite the coils 201 and 202 in predetermined patterns as described later. A detection unit 208 detects voltage or current generated by the 201 and 202 and notifies the control unit 205 that objects of some kind are placed in areas corresponding to the charging units 201A and 201B. The control unit 205 causes an LED 209 to emit light according to an operating state of the charging apparatus 200 to send messages to a user such as an error in charge, a change in charging state, or completion of charge.

A communication unit 210 is a circuit for communicating with an external device including the charge target device 300. With the communication unit 210, a data processing unit 211 processes communication data used by the control unit 205 for controlling. A signal processing unit 212 demodulates the received signal and then separates data at the time of receiving a signal. The signal processing unit 212 performs processing on the data and then modulates the signal to convert it to a signal adapted for communication at the time of transmitting a signal. The communication unit 210 further includes an antenna 213.

These functions enable the communication unit 210 to transmit information to an external communicable device and receive information from the external communicable device. The communication unit 210 performs wireless communication using a known communication technique such as Bluetooth, wireless LAN, or Wi-Fi.

On the other hand, the charge target devices 300 are placed on the charging units 201A and 201B of the charging apparatus 200 to cause a current to flow in a coil 301 of the secondary coil due to magnetic flux generated by the coils 201 and 202. Since a voltage supplied from the coil 301 is unstable, the voltage is rectified and smoothed by a rectification and smoothing unit 302 to be supplied to a power supply control unit 303. The power supply control unit 303 charges a secondary battery 304 by the voltage from the rectification and smoothing unit 302. The power supply control unit 303 detects the state of the secondary battery 304 through the voltage and charge time of the secondary battery 304 to control the supply of electric power to the secondary battery. A lithium ion battery or a nickel metal hydride battery, for example, may be used as the secondary battery 304. The secondary battery 304 can be attached to or detached from the charge target device 300.

A communication unit 305 communicates with an external apparatus such as the charging apparatus 200. A signal processing unit 307 in the communication unit 305 performs predetermined processing on data transferred through an antenna to convert it to data for processing and to a transmittable form. A communication control unit 308 receives and transfers data through a power supply control unit 303 or sends data to the power supply control unit 303. A memory 309 stores data used for the charge processing of the power supply control unit 303.

FIG. 2B illustrates only blocks related to the charge processing in the charge target device 300 according to the present exemplary embodiment. As illustrated in FIG. 1, if the charge target device 300 is the cellular phone 300A, for example, other function blocks for realizing the functions of the cellular phone are further provided in addition to the configuration illustrated in FIG. 2B. Also in a digital camera 300B, the processing blocks related to the charge processing according to the present exemplary embodiment are similar to the charge target device 300 illustrated in FIG. 2B. The digital camera 300B has function blocks for realizing the functions of the digital camera in addition to the configuration illustrated in FIG. 2B.

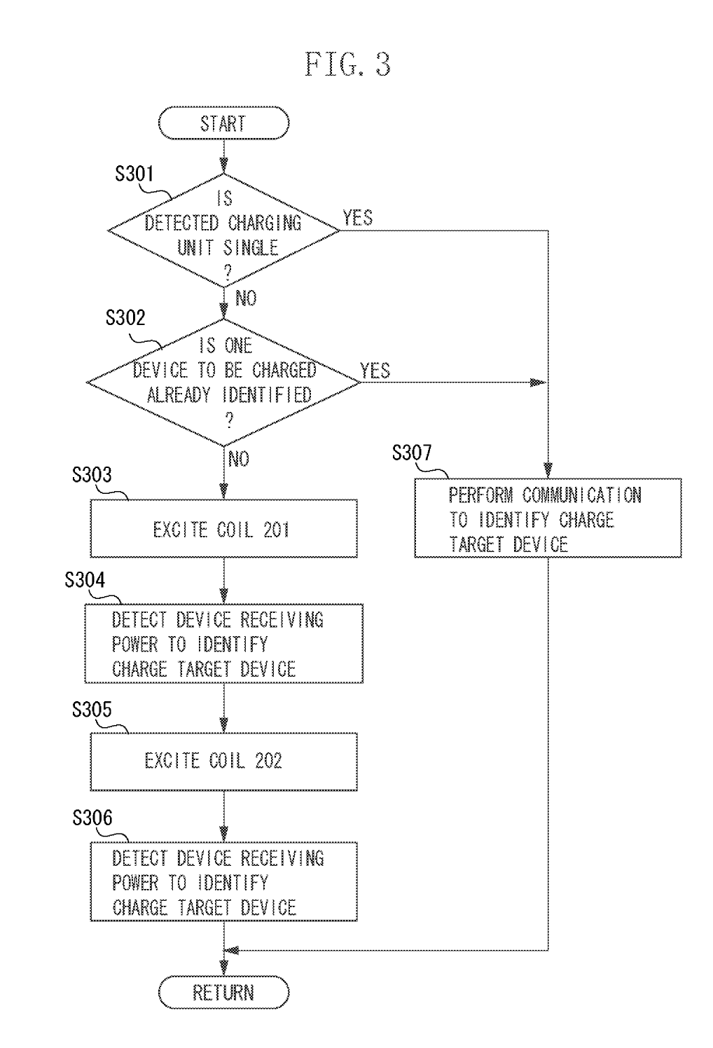

Processing for identifying a charge target device 300 by the charging apparatus 200 is described below with reference to a flow chart in FIG. 3. The processing in FIG. 3 is executed by the control unit 205. The charging apparatus 200 in FIG. 1 is not especially equipped with a power supply switch. Plugging of the power supply plug 214 into a wall socket automatically turns on the power supply.

When the power supply of the charging apparatus 200 is turned on, the detection unit 208 detects change in voltage or current of coils 201 and 202 and notifies the control unit 205 of the change. When the control unit 205 detects that an object is placed on at least one of the charging units 201A and 201B, the processing flow starts.

If an object such as a charge target device is placed on the charging units 201A and 201B of the charging apparatus 200, the inductance of the coils 201 and 202 more or less changes in comparison with the case where nothing is placed thereon. The control unit 205 causes the coil exciting units 206 and 207 to excite the coils 201 and 202 for a short time in a predetermined period. At this point, the detection unit 208 detects current flowing into the coils 201 and 202 to detect a change in the inductance. The above processing enables detecting of an object such as a charge target device, which is placed on the charging units 201A and 201B.

In step S301, the control unit 205 determines whether an object is placed on only one charging unit. If the object is placed on only one charging unit (YES in step 301), in step 307, the communication unit 210 communicates with the object. If the placed object is the charge target device 300, the communication unit 210 inquires of the charge target device 300 what kind of device it is. The communication unit 210 obtains information about the charge target device 300 based on the response transmitted from the charge target device 300 in response to the inquiry. The control unit 205 identifies the charge target device 300 based on the information obtained from the communication unit 210.

In the present exemplary embodiment, information such as the charge capacity of a battery and the maximum charge voltage is obtained as information of the charge target device 300. The control unit 205 controls the coil excitation unit corresponding to the charging unit on which the charge target device is placed, among the coil exciting units 206 and 207, according to the information obtained by the communication unit 210 to transmit electric power suited for the charge target device.

On the other hand, if the control unit 205 determines that objects are placed on both the charging units 201A and 201B (NO in step S301), in step S302, the control unit 205 determines whether the charge target device placed on the one charging unit has been already identified.

For example, if the charge target device is previously placed on the one charging unit and then another object is placed on the other charging unit, the charge target device previously placed has been identified. In such a case (YES in step 302), the processing proceeds to step S307 and the communication unit 210 communicates with the devices. If two charge target devices 300 are placed, the communication unit 210 receives response from the two charge target devices 300. However, since the one charge target device 300 has been already identified, another charge target device 300 can be identified as a newly placed device. Therefore, the respective charge target devices 300 placed on the two charging units 201A and 201B can be identified.

If none of the devices have been identified (NO in step S302), in step S303, the coil 201 is excited first and excitation of the coil 202 is stopped. In step S304, the communication unit 210 communicates with the devices to inquire of the coil 301 if it receives electric power. At this point, the communication unit 210 receives response from the two charge target devices 300. Since only the coil 201 is excited, it is clear that the device notifying that it is receiving electric power is the one to which the coil 201 transmits electric power. For this reason, the device notifying that it is receiving electricity can be identified as the one placed on the charging unit 201A.

In step S305, the coil 202 is excited and the excitation of the coil 201 is stopped. In step S306, the communication unit 210 communicates with the charge target devices 300 to inquire of them if they are receiving electric power. As described above, the device notifying that it is receiving electric power is the one to which the coil 202 transmits electric power, so that the device placed on the charging unit 201B can be identified.

Thus, when the identification of the charge target device placed on each charging unit is finished, the control unit 205 starts the processing for charging each device. The control unit 205 controls the coil exciting units 206 and 207 according to the information obtained by the communication unit 210 to transmit electric power suited for charging each charge target device.

The above description deals with the processing for identifying a charge target device in the system including one charging apparatus 200 and two charge target devices 300A and 300B as illustrated in FIG. 1.

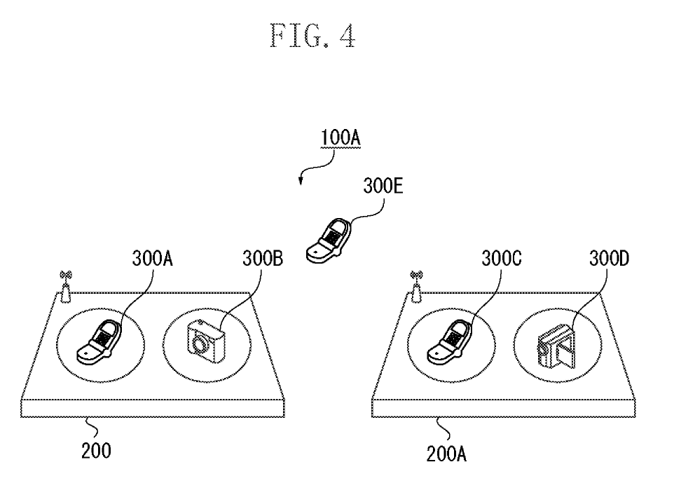

There may be a situation as illustrated by a charging system 100A in FIG. 4, for example. In FIG. 4, there exist a charging apparatus 200A similar in configuration to the charging apparatus 200, cellular phones 300C and 300E, and a video camera 300D as well as the charging apparatus 200, the cellular phone 300A, and the digital camera 300B.

If the devices 300C to 300E exist within an area where the charging apparatus 200 can communicate with the devices, the apparatus 300C to 300E respond to the inquiry from the communication unit 210 as described in FIG. 3. Furthermore, if the cellular phone 300C and the video camera 300D are being charged by the charging apparatus 200A, the cellular phone 300C and the video camera 300D send response that they are being charged. As a result, it cannot be identified which of the devices 300A to 300D is placed on the charging apparatus 200.

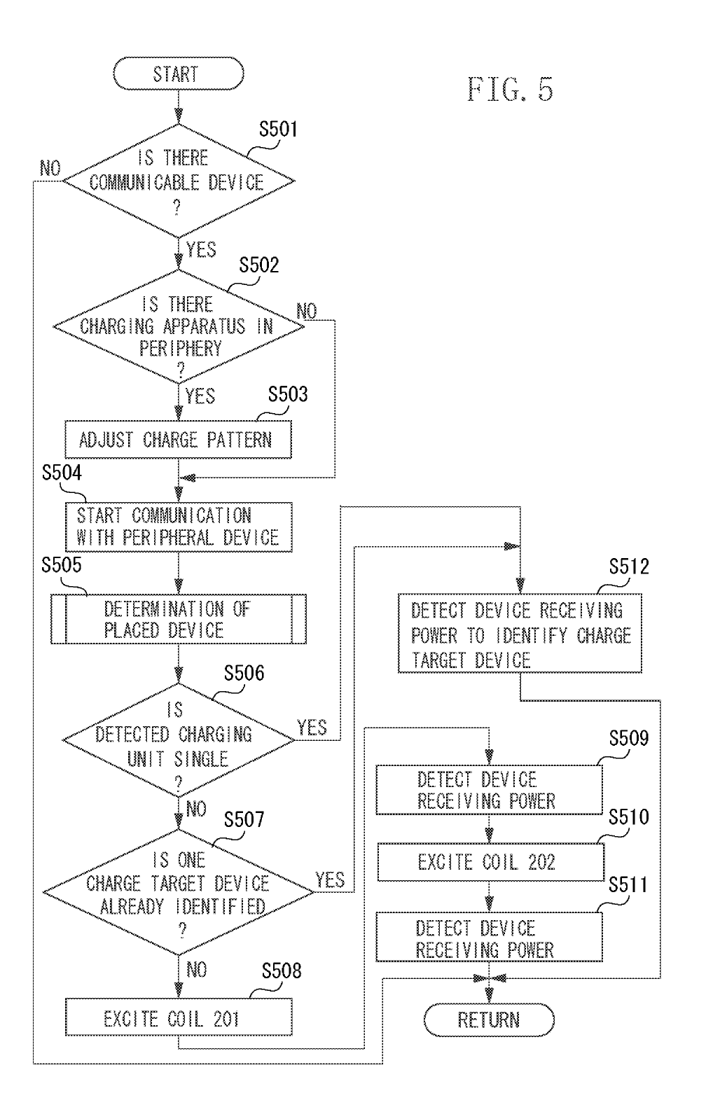

Accordingly, in the present exemplary embodiment, an identification processing is executed according to the flow chart in FIG. 5 to identify a charge target device placed on the charging apparatus 200. The processing in FIG. 5 is executed by the control unit 205.

When the detection unit 208 detects change in voltage or current of coils 201 and 202 and the control unit 205 detects that that a charge target device is placed on at least one of the charging units 201A and 201B, the processing flow starts.

In step S501, the control unit 205 determines whether a charge target device communicable with the communication unit 210 exists in the periphery. If there is no communicable charge target device in the periphery (NO in step S501), it is determined that the device placed on the charging apparatus 200 is not a charge target device and the processing ends.

In step S502, if a charge target device responds to the inquiry (YES in step S501), in step S502, the control unit 205 determines whether there is a charging apparatus similar in function to the charging apparatus 200 based on the response received by the communication unit 210. If the control unit 205 detects a charging apparatus, for example, the charging apparatus 200A in the periphery in FIG. 4 (YES in step S502), in step S503, a charge on-off pattern adjustment is performed between the charging apparatus.

The charge on-off pattern adjustment is described below.

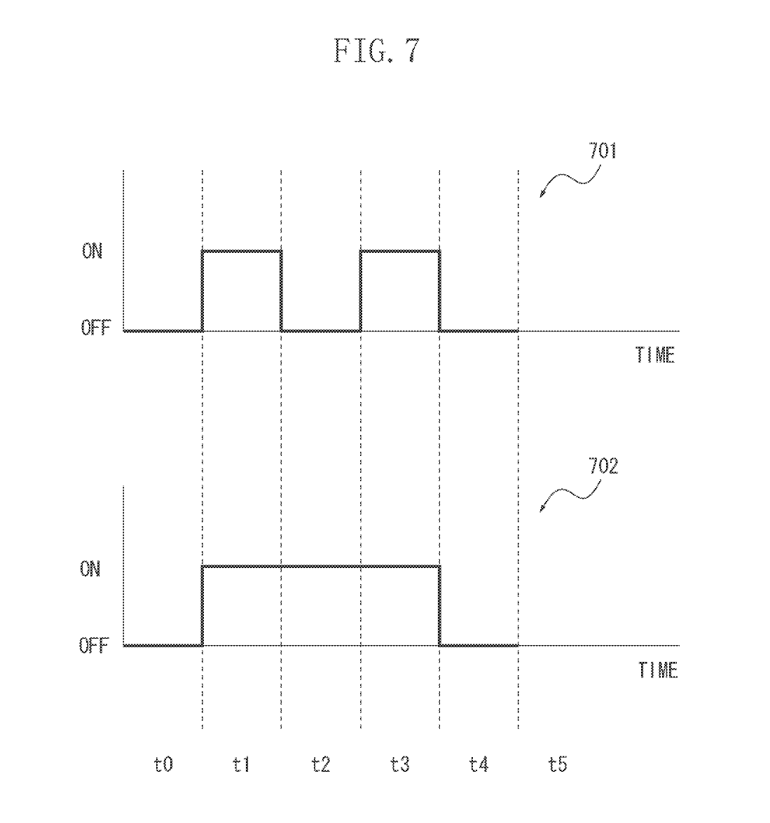

After the charging apparatus was detected, the adjustment is performed between the charging apparatus to prevent the duplication of the pattern signal used to detect a device placed on the charging apparatus 200 in the processing described later. In the present case, the adjustment is made so that the charging apparatus 200 uses a pattern signal 701 illustrated in FIG. 7 and the charging apparatus 200A uses a pattern signal 702 illustrated in FIG. 7.

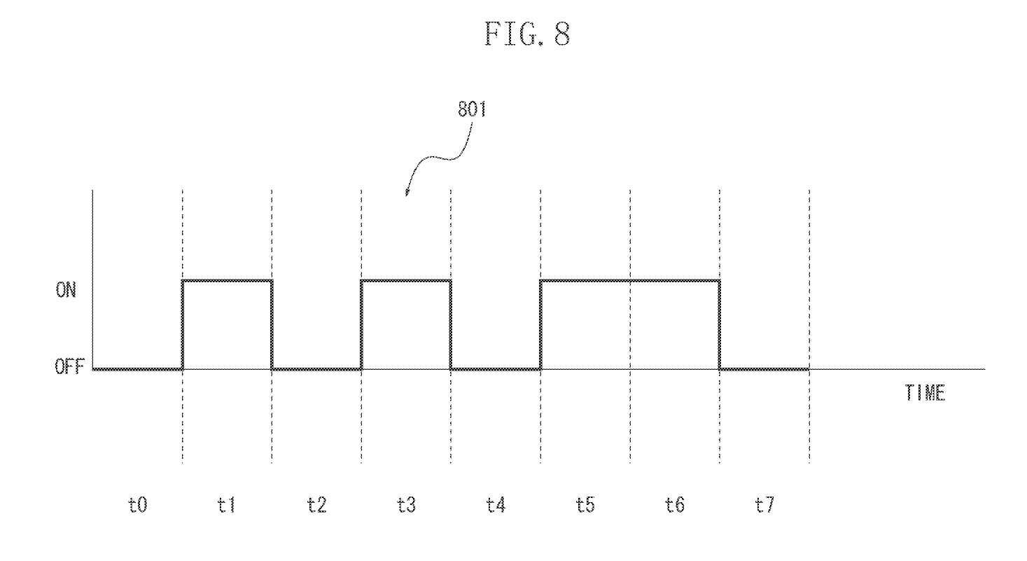

If there is no charging apparatus similar in function to the charging apparatus 200 (NO in step S502), the charging apparatus 200 uses an appropriate pattern signal 801 as illustrated in FIG. 8. In FIGS. 7 and 8, when the signal is turned on, the coils 201 and 202 are excited. When the signal is turned off, the excitation of the coils 201 and 202 is stopped.

In step S504, the communication unit 210 starts communicating with all the peripheral charge target devices. In FIG. 4, the charging apparatus 200 communicates with the cellular phone 300A, the digital camera 300B, the cellular phone 300C, the video camera 300D, and the cellular phone 300E. In step S505, processing for determining a placed device is executed.

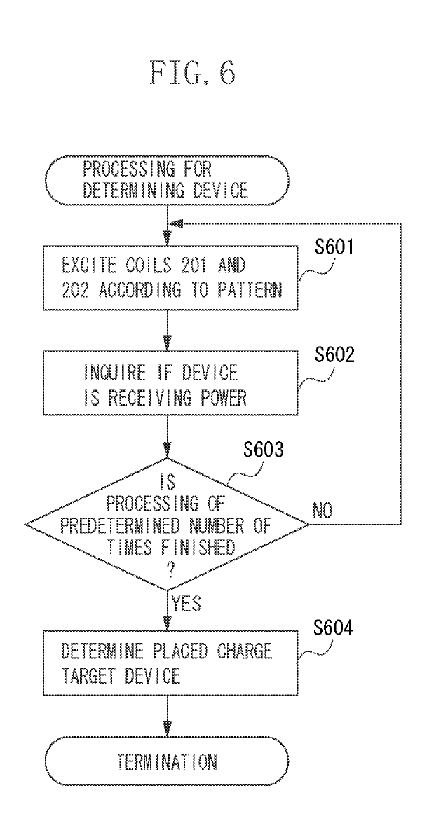

The processing for determining a placed device in step S505 is described below with reference to a flow chart in FIG. 6.

In step S601, the control unit 205 controls the coil exciting units 206 and 207 according to the pattern signal, e.g., the signal 701 in FIG. 7 determined by the processing in step S503 to switch the exciting state of the coils 201 and 202 in the same manner. Each pattern signal is stored in a memory (not shown). As illustrated in FIG. 7, the pattern signal 701 is turned on and off in a determined period of t0 to t4. For example, the pattern signal 701 is turned off in a period of t0, so that both the excitation of the coils 201 and 202 is stopped. In step S602, the communication unit 210 inquires of the charge target device with which it is communicating, if it is receiving electric power. For example, in FIG. 4, the cellular phone 300A and the digital camera 300B send response that they are not receiving electric power because the excitation of the coils 201 and 202 is stopped. On the other hand, it is unclear whether the cellular phone 300C and the video camera 300D sends response that they are receiving electric power or not because their charge processing is controlled by the charging apparatus 200A. The cellular phone 300E is not being charged, so that the cellular phone 300E sends response that it is not receiving electric power.

At this point, the processing in one period of the pattern signal is finished. In step S603, the control unit 205 determines whether the processing in all the periods of t0 to t4 is finished. Since only the processing in the period of t0 is finished at this point, the processing in the period of t1 is executed. The coils 201 and 202 are excited in the period of t1. The communication unit 210 again inquires of the charge target devices.

The cellular phone 300A and the digital camera 300B send response that they are receiving electric power in the period of t1. On the other hand, the response of the cellular phone 300C and the video camera 300D is unclear. The cellular phone 300E is not being charged, so that the cellular phone 300E sends response that it is not receiving electric power. Thus, since the cellular phone 300E sends response different from the exciting pattern, it becomes known that the cellular phone 300E is not placed on the charging apparatus 200. Therefore, the communication unit 210 stops communicating with the cellular phone 300E.

Thus, switching an exciting state and inquiring of each device about the reception of electric power are repeated according to the pattern signal. The charging apparatus 200 and 200A switch an exciting state and inquire of a charge target device in the same period according to the pattern signals 701 and 702 in FIG. 7 respectively. In this case, even if each charging apparatus performs the processing of steps S601 and S602 at the same time, the cellular phone 300C and the video camera 300D return response different from the exciting state of the charging apparatus 200 during the period of t0 to t4 in FIG. 7. Accordingly, it can be determined that the cellular phone 300C and the video camera 300D are not placed on the charging apparatus 200. If the pattern signal in FIG. 8 is used, the same processing is repeated in the period of t0 to t7.

In step S604, it can be determined by the above processing (steps S601 to S603) that the cellular phone 300A and the digital camera 300B are charge target devices placed on the charging apparatus 200.

A device placed on the charging apparatus 200 is thus determined and then the control unit 205 executes the processing in step S506 and subsequent steps. Steps S506 to S512 are similar in processing to steps S301 to S307 in FIG. 3, so that description thereof is omitted.

In the present exemplary embodiment, an adjustment is performed between the two charging apparatus 200 and 200A to prevent pattern signals from overlapping with each other. However, a pattern signal can use a random number, for example, which is hard to overlap, or a pattern signal illustrated in FIG. 8, which is longer in a period, instead of adjusting the pattern signal.

In the present exemplary embodiment, while the charging apparatus with two charging units is described, a charge target device placed on each charging unit can similarly be identified when the charging apparatus has three or more charging units.

In the processing of FIGS. 5 and 6, a charge target device placed on the charging apparatus 200 is first determined and then a charge target device placed on each charging unit is identified. However, in FIG. 6, an inquiry can be made about a power receiving state, by exciting only one coil according to the pattern signal instead of making an inquiry by exciting two coils simultaneously.

More specifically, in the processing of step S601, for example, the coil 201 is excited according to the pattern signal and the excitation of the coil 202 remains stopped. As a result of inquiring of each device about a power receiving state, a device making a response that the exciting state by the pattern signal corresponds to the power receiving state, can be identified as a device placed on the charging units 201A. The coil 202 is controlled in the same manner so that a device placed on the charging units 202A can be identified.

In that case, the processing in step S506 and subsequent steps is not performed.

According to the present exemplary embodiment, a charge target device placed on a plurality of charging units can be identified. The exciting state of a coil corresponding to the plurality of charging units is controlled according to information received from each device to enable supply of an optimum electric power to each device.

In the first exemplary embodiment, the exciting state of a coil is controlled by the pattern signal to identify a device placed on the charging apparatus 200. In the present exemplary embodiment, on the other hand, the pattern signal is multiplexed on the control signal of the coil exciting unit to excite the coil.

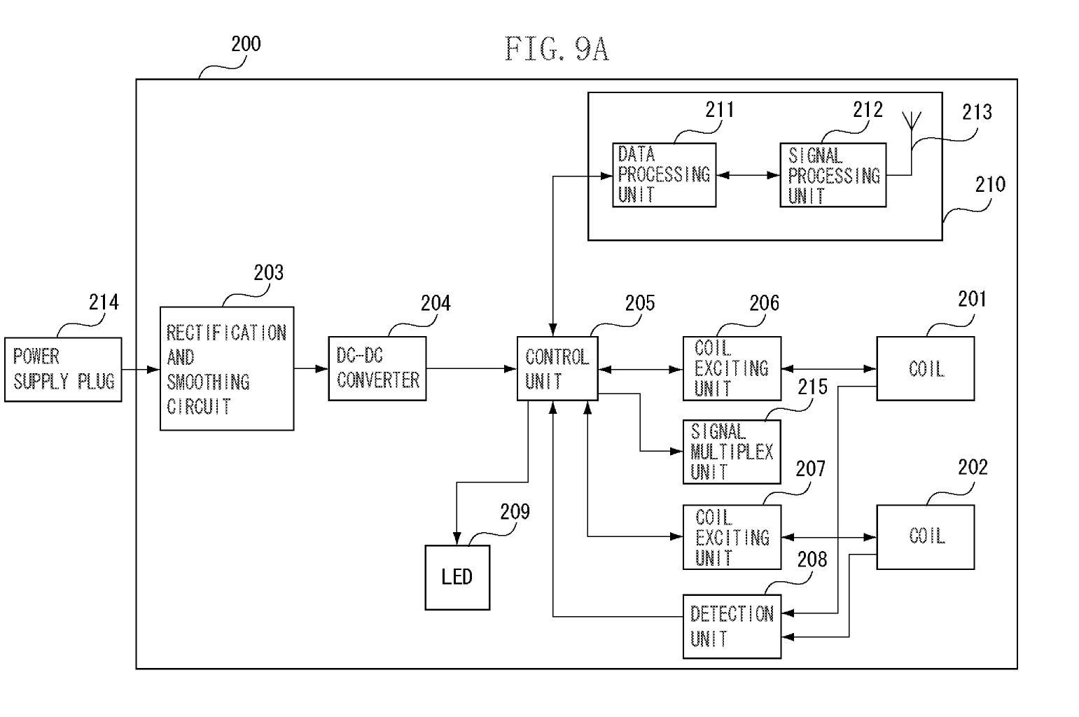

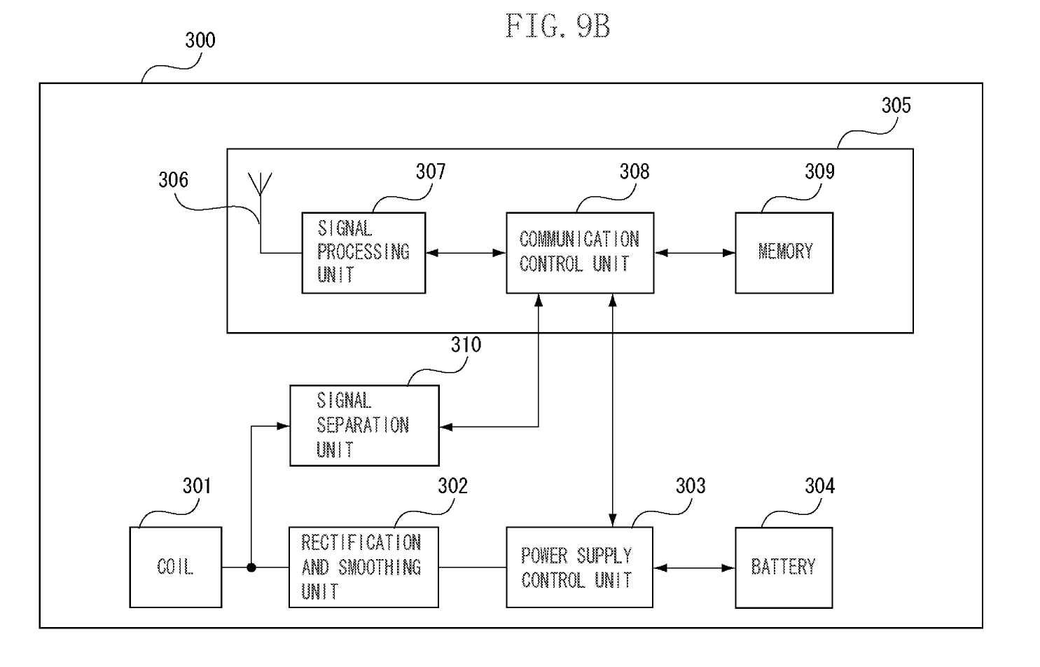

FIG. 9A is a block diagram illustrating a configuration of the charging apparatus 200 and FIG. 9B is a block diagram illustrating a configuration of a charge target device 300A of the charging system 100 in the present exemplary embodiment. The components similar to those of FIGS. 2A and 2B are denoted by the same reference numerals and detailed description thereof is omitted.

In FIG. 9A, a signal multiplex unit 215 multiplexes a specific signal on the signals of the coil exciting units 206 and 207. In FIG. 9B, a signal separation unit 310 separates a specific signal component from exciting energy sent from the coil 301 and sends it to the communication control unit 308.

The communication unit 305 is requested to transmit the pattern signal, by the charging apparatus 200 to transmit the pattern signal detected by the signal separation unit 310 to the charging apparatus 200.

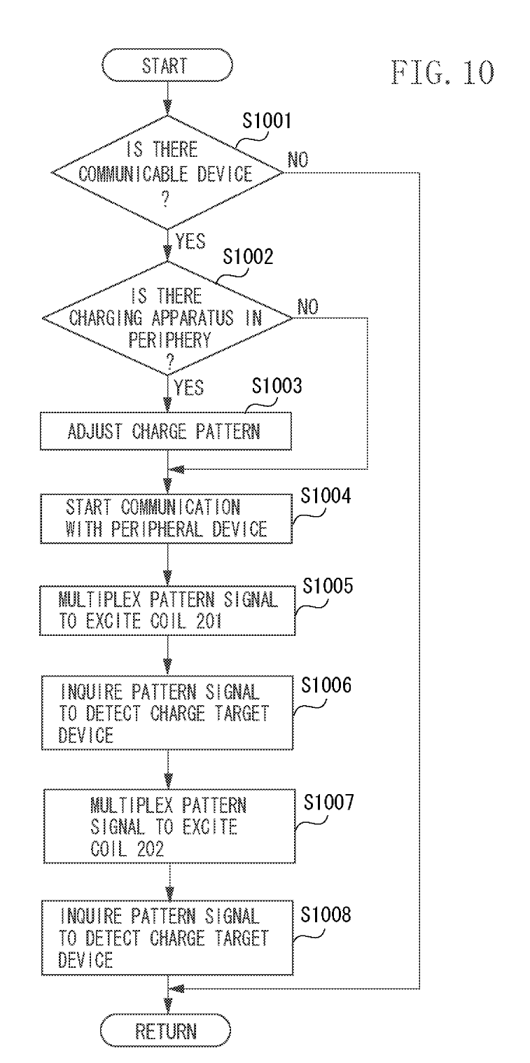

Processing for identifying a charge target device in the present exemplary embodiment is described below with reference to a flow chart in FIG. 10. In FIG. 10, steps S1001 to S1004 are similar in processing to steps S501 to S504, so that description thereof is omitted.

As described above, the charging apparatus 200 performs a charge pattern adjustment with other charging apparatus and starts communicating with the charge target devices. Thereafter, in step S1005, the pattern signal 701 in FIG. 7, for example, is multiplexed on the control signal of the coil exciting unit 206 to excite the coil 201. The signal separation unit 310 in the charge target device 300 separates the pattern signal from the output of the coil 301 and outputs it to the communication control unit 308.

In step S1006, the communication unit 210 requests each device to send back the detected pattern. In this case, it is the cellular phone 300A that can send back the pattern signal 701, so that it can be found that the charge target device placed on the charging unit 201A is the cellular phone 300A.

In steps S1007 and S1008, the coil 202 is subjected to the similar processing. As a result, it can be found that the charge target device placed on the charging unit 202A is the digital camera 300B.

Thus, according to the present exemplary embodiment, charge target devices placed on a plurality of charging units can be identified. The exciting state of the coil is controlled according to the information from each device, so that an optimum electric power can be supplied to each device.

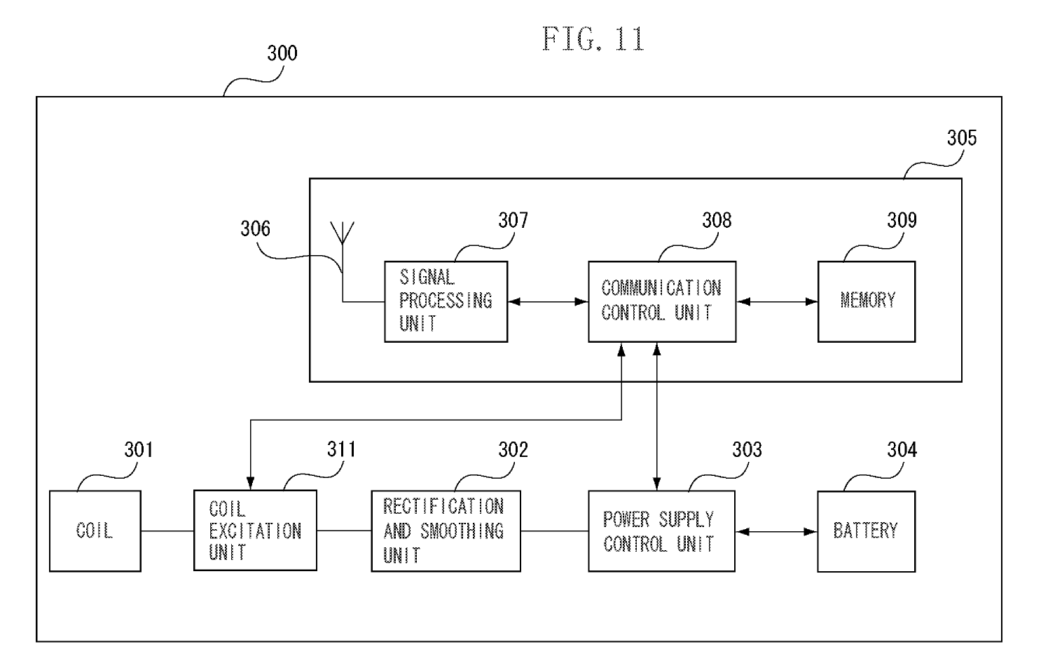

According to the third exemplary embodiment, a charge target device can excite a coil. FIG. 11 is a block diagram illustrating a configuration of the charge target device 300 according to the third exemplary embodiment. The components similar to those of FIG. 2B are denoted by the same reference numerals and detailed description thereof is omitted. FIG. 11 is different from FIG. 2B in that a coil excitation unit 311 is added to the charge target device 300. The configuration of the charging apparatus in the third exemplary embodiment is the same as the configuration of the charging apparatus 200 illustrated in FIG. 2A. The detailed description thereof is omitted.

When the communication unit 305 in the charge target device 300 is requested from the charging apparatus 200 to excite the coil, the communication control unit 308 controls the coil excitation unit 311 to excite the coil 301 for a predetermined period. If the charge target device 300 is placed on the charging apparatus 200, an electromotive force is generated in the coils 201 or 202 according to the exciting operation of the coil 301 by the coil excitation unit 311.

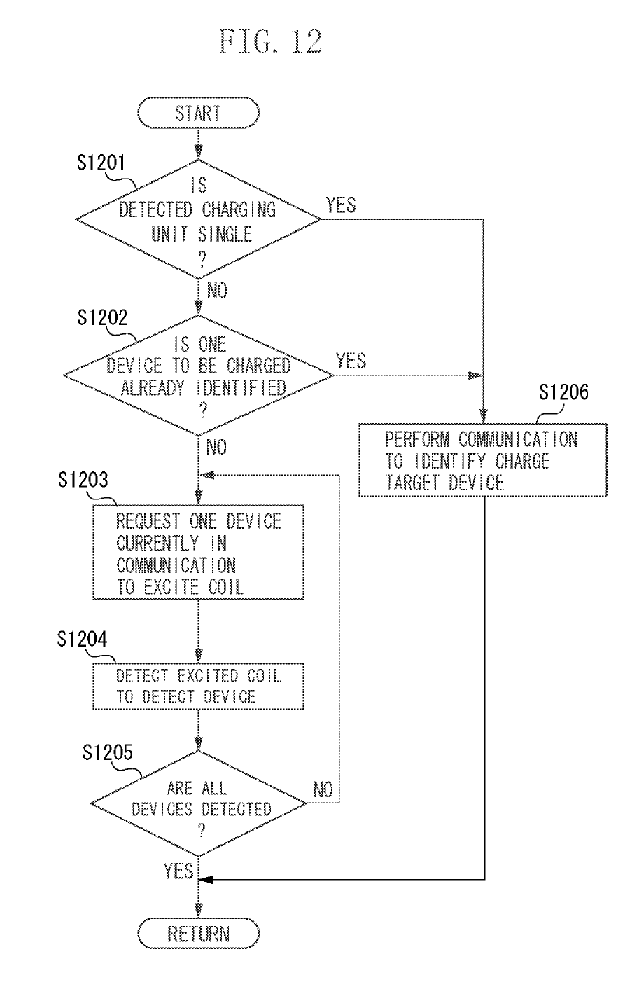

Processing for identifying a charge target device according to the present exemplary embodiment is described below with reference to a flow chart in FIG. 12. Steps S1201, S1202, and S1206 in FIG. 12 are similar in processing to steps S301, 5302, and 5307 in FIG. 3 respectively.

In step S1201, the control unit 205 determines whether there is only one charging unit on which an object is placed. If the object is placed on only one charging unit (YES in step 1201), the communication unit 210 communicates with the object to identify the charge target device in step S1206.

If the control unit 205 determines that objects are placed on both the charging units 201A and 201B (NO in step S1201), in step S1202, the control unit 205 determines whether the charge target device placed on the one of the charging units has been identified. If the charge target device placed on the one of the charging units has been identified (YES in step 1202), the processing proceeds to step S1206 and the communication unit 210 communicates with an object to identify a newly placed charge target device.

If neither of devices has been identified (NO in step 1202), in step S1203, the communication unit 210 selects any one of a plurality of charge target devices with which it is communicating and requests the selected device to excite the coil. In this case, the cellular phone 300A is requested to excite the coil. Then, the coil of the cellular phone 300A is excited to change the magnetic flux around the coil 201 and electromotive force is generated. The detection unit 208 detects the electromotive force generated in the coil 201 and sends it to the control unit 205. Thus, in step S1204, it is found that the cellular phone 300A is placed on the charging unit 201A.

If the one charge target device is identified, in step S1205, the control unit 205 determines whether all the charge target devices are identified. If there exists an unidentified charge target device, in step S1203, all the devices with which it is communicating, are similarly requested to excite the coils. Thus, it is eventually detected that the cellular phone 300A is placed on the charging unit 201A and the digital camera 300B is placed on the charging unit 202A.

Thus, according to the present exemplary embodiment, charge target devices placed on a plurality of charging units can be identified. The exciting state of the coil is controlled according to the information from each device, so that an optimum electric power can be supplied to each device.

In recent years, a communication apparatus has been in widespread use such as an IC card typified by RFID using a close proximity wireless communication technique. In the present exemplary embodiment, communication is made with charge target devices using such a close proximity wireless communication technique to identify a charge target device placed on a charging apparatus.

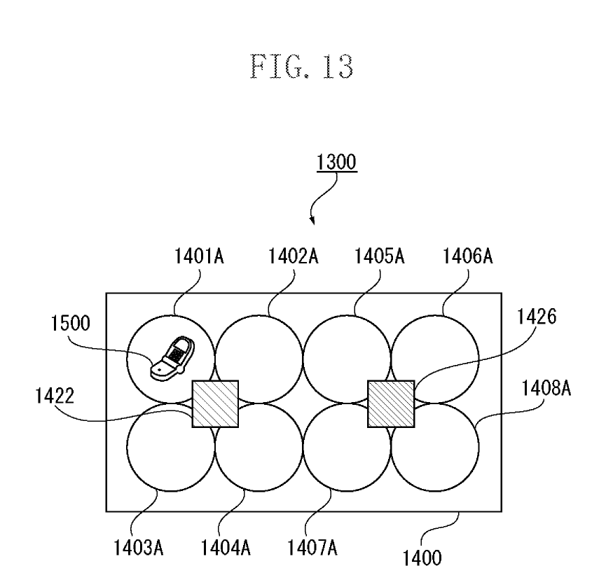

FIG. 13 is a schematic diagram of a charging system 1300 in the present exemplary embodiment. In FIG. 13, similar to the above exemplary embodiments, a charging apparatus 1400 performs charge in a non-contact manner using electromagnetic induction. The charging apparatus 1400 is in a plate shape and equipped with eight charging units 1401A to 1408A each including a charging coil.

The charging apparatus 1400 incorporates two communication units 1422 and 1426. The communication units 1422 and 1426 communicate with charge target devices using a close proximity wireless communication. The communication unit 1422 is capable of communicating with the charge target device placed on any of the charging units 1401A to 1404A. The communication unit 1426 is capable of communicating with the charge target device placed on any of the charging units 1405A to 1408A. The communication units 1422 and 1426 send electric power used for communication to the communication units of charge target devices to communicate with the devices. The communication units 1422 and 1426 are actually incorporated into the charging apparatus 1400, so that the communication units 1422 and 1426 are invisible from the outside.

A charge target device 1500 is placed on any of the charging units in the charging apparatus 1400 to enable charging of the battery of the charge target device 1500. The charge target device 1500 is similar in configuration to the charge target device 300 illustrated in FIG. 2B and receives electric power in a non-contact manner to charge the battery. The present exemplary embodiment is different from the exemplary embodiment in FIG. 2B in that the communication unit 305 communicates with the charging apparatus 1400 using a close proximity wireless communication.

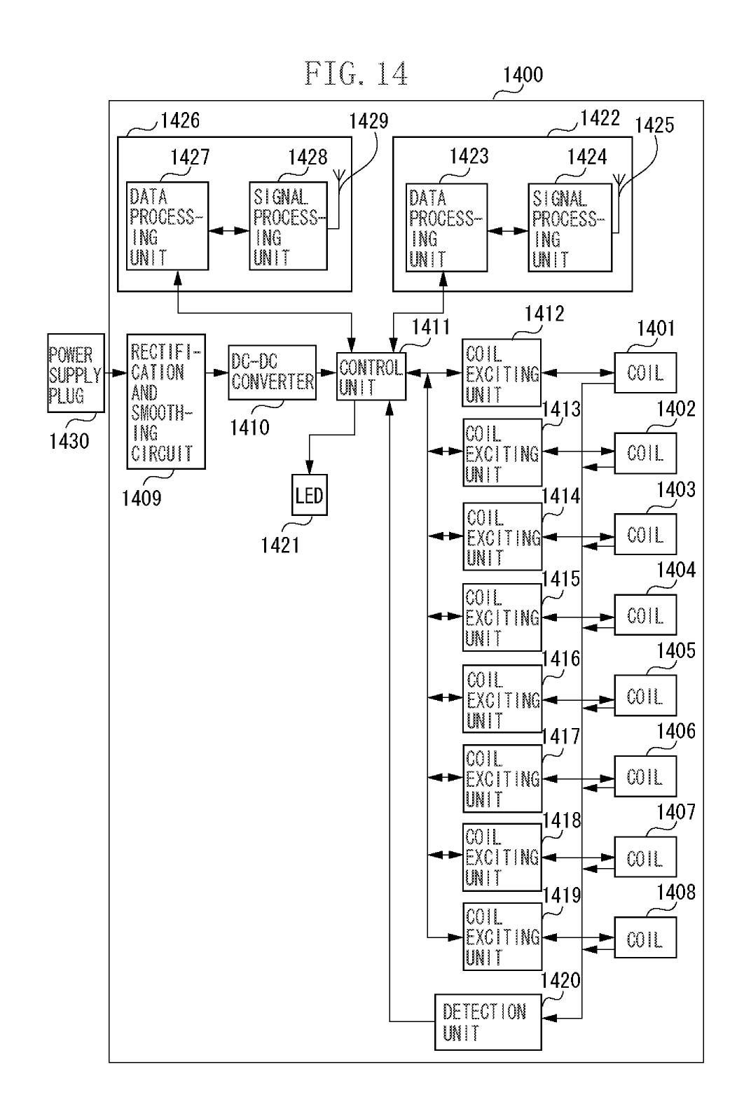

FIG. 14 is a block diagram illustrating a configuration of the charging apparatus 1400.

The charging apparatus 1400 has a function substantially similar to the charging apparatus 200 in FIG. 2A and includes coils 1401 to 1408 and coil excitation units 1412 to 1419 which correspond to eight charging units 1401A to 1408A. The control unit 1411 controls the coil excitation units 1412 to 1419 based on the electric power from a DC-DC converter 1410 to charge the charge target device 1500 placed on the charging apparatus 1400. When a charge target device is placed on any of the charging units 1401A to 1408A, a detection unit 1420 informs the control unit 1411 accordingly. The charging apparatus 1400 also has a certification and smoothing circuit 1409 to which an AC voltage is supplied from a power supply plug 1430, a LED 1421, a communication unit 1422,1426, a data processing unit 1423,1428, a signal processing unit 1424,1427, an antenna 1425,1429, similar to the charging apparatus 200.

The charging apparatus 1400 includes two communication units 1422 and 1426.

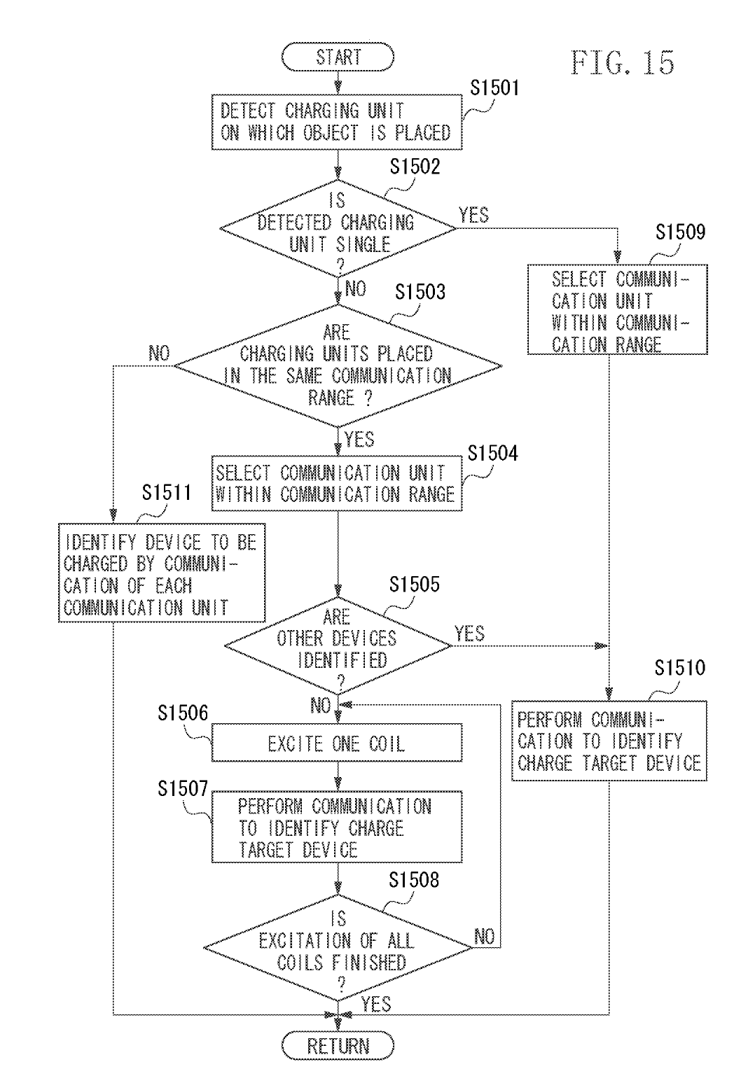

Processing for identifying a charge target device in the present exemplary embodiment is described below with reference to a flow chart in FIG. 15.

In step S1501, an object is placed on the charging apparatus 1400, which changes the output of any of the coils and the detection unit 1420 informs the control unit 1411 of a change of coil (charging unit) output. In step S1502, the control unit 1411 determines whether there is only one charging unit on which the object is placed. If the object is placed on anyone of the charging units and other objects are not placed on the other charging units (YES in step S1501), in step S1509, the control unit 1411 selects the communication unit including the detected charging unit within its communication range from among two communication units 1422 and 1426. In step S1510, the selected communication unit communicates with the object. If the placed object is the charge target device 1500, the communication unit inquires of the charge target device 1500 what kind of apparatus it is, and obtains the information about the charge target device 1500. In step S1510, the control unit 1411 identifies the charge target device based on the information obtained from the communication unit.

Also in the present exemplary embodiment, information such as the charge capacity of a battery and the maximum charge voltage is obtained as information of the charge target device. The control unit 1411 controls the coil excitation unit corresponding to the charging unit on which the charge target device 1500 is placed to transmit electric power suited for the charge target device.

If the control unit 1411 determines that objects are placed on a plurality of charging units (NO in step S1502), in step S1503, the control unit 1411 determines whether the detected charging unit is the one in the communication range of the same communication unit. If the charging unit on which an object is placed is in the communication ranges of the communication units 1422 and 1426 which are different from each other (NO in step 1503), in step S1511, the communication units 1422 and 1426 perform communication similar to that in step S1510 to identify the charge target device 1500.

If the control unit 1411 determines that the detected plurality of charging units is in the communication range of the same communication unit (YES in step S1503), in step S1504, the control unit 1411 selects the communication unit including the detected charging unit within its communication range from among two communication units. In step S1505, the control unit 1411 determines whether the charge target device placed on the charging unit except the newly detected charging unit has been already identified.

For example, if a charge target device is previously placed on one charging unit and then another object is placed on another charging unit in the same communication range, the previously placed charge target device has been identified (YES in step s1505). In that case, the processing proceeds to S1510 and the communication unit selected in step S1504 performs communication. At this point, if two charge target devices 1500 are placed, the communication unit receives response from two charge target devices. Since the one charge target device has been already identified, the other device can be identified as a newly placed device. Thus, the devices placed on the two charging units can be identified.

If none of the devices can be identified (NO in step S1505), in step S1506, the coil corresponding to one charging unit among a plurality of charging units detected in step S1501 is excited and the excitation of other coils is stopped. In step S1507, the selected communication unit performs communication to inquire whether the coil 301 of the charge target device is receiving electric power. At this point, the communication unit may receive response from a plurality of charge target devices. However, it becomes known that the device sending response that it is receiving electric power is the one to which the excited coil transmits electric power. Thereby, the device sending response that it is receiving electric power can be identified as the device placed on the charging unit corresponding to the excited coil.

In step S1508, the control unit 1411 determines whether all the charging units detected in step S1501 are subjected to the processing in steps S1506 and S1507. Thus, each charging unit is subjected to the similar processing to identify the charge target device 1500 placed on it.

The control unit 1411 identifies the charge target device placed on each charging unit and controls the coil excitation units 1412 to 1419 according to the information obtained by the communication unit to transmit electric power suited for charging the charge target device.

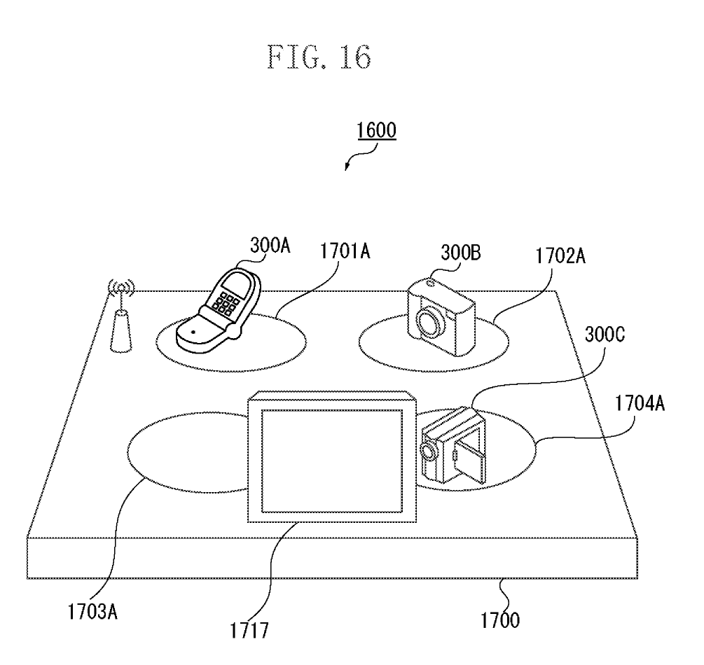

FIG. 16 is a schematic diagram illustrating a configuration of a charging system 1600 according to the fifth exemplary embodiment. The charging system 1600 includes a charging apparatus 1700 and a charge target device 300. Also in the present exemplary embodiment, the charging apparatus 1700 performs charge in a non-contact manner using electromagnetic induction as is the case with the foregoing charging apparatus 200. The charging apparatus 1700 incorporates a coil for performing charge in a non-contact manner. The charge target devices 300 are placed on four charging units 1701A to 1704A for supplying electric power through the incorporated coils, so that batteries incorporated in the charge target devices 300 can be charged.

FIG. 16 illustrates the cellular phone 300A, the digital camera 300B, and a video camera 300C as the charge target device 300. However, the present invention is applicable to other devices which can communicate with the charging apparatus 1700.

As is the case with the charging apparatus 200, the charging apparatus 1700 identifies the charge target device 300 placed on the charging units 1701A to 1704A by the processing described in the above exemplary embodiments. The charging apparatus 1700 further includes a display unit 1717. The display unit 1717 displays icons indicating charge target devices placed on the charging units 1701A to 1704A and buttons indicating a function executed to the charge target devices. The display unit 1717 is a touch panel in which a user touches the display unit 1717 to input various instructions.

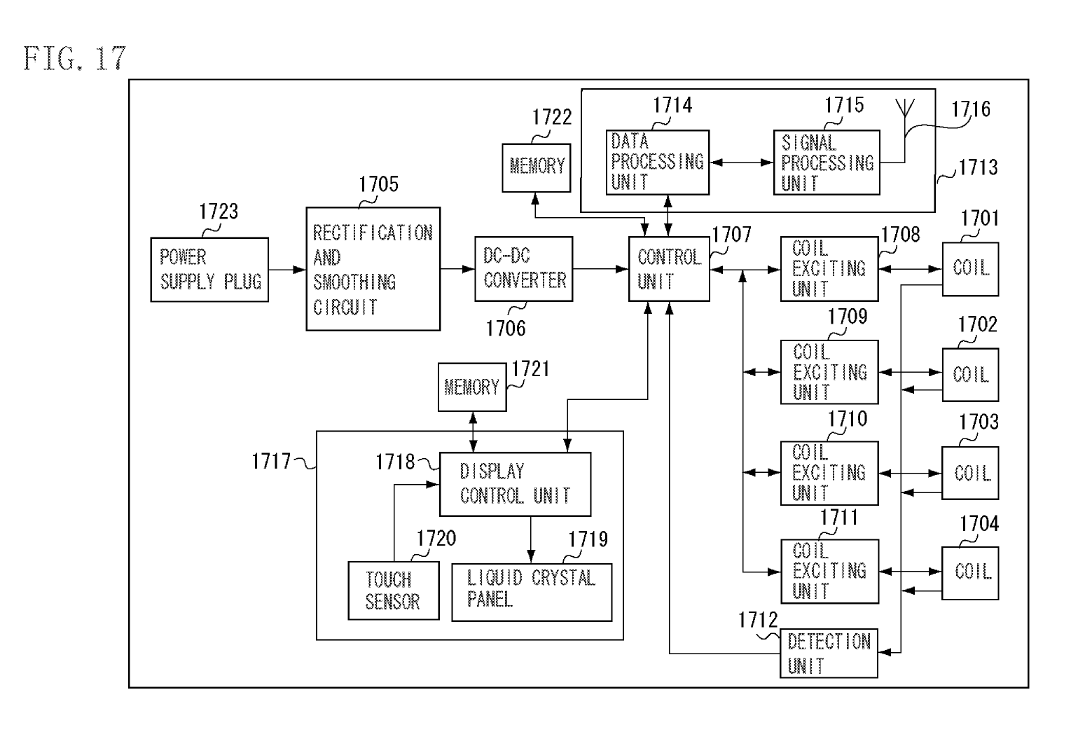

FIG. 17 is a block diagram illustrating a configuration of the charging apparatus 1700.

The charging apparatus 1700 has a function substantially similar to the charging apparatus 200 in FIG. 2A and includes coils 1701 to 1704 and coil excitation units 1708 to 1711 which correspond to four charging units 1701A to 1704A. The control unit 1707 controls the coil excitation units 1708 to 1711 based on the electric power from a DC-DC converter 1706 to charge the charge target device 300 placed on the charging apparatus 1700.

The charging apparatus 1700 performs the processing similar to that in the first exemplary embodiment, for example, to identify charge target devices placed on the charging units 1701A to 1704A, so as to control charge processing.

The charging apparatus 1700 is different from the charging apparatus 200 in that the charging apparatus 1700 is equipped with a display unit 1717 and a memory 1721. The display unit 1717 includes a display control unit 1718, a liquid crystal panel 1719, and a touch sensor 1720. The display control unit 1718 displays icons corresponding to charge target devices placed on the charging units 1701A to 1704A on the liquid crystal panel 1719 according to instructions of the control unit 1707.

The display control unit 1718 displays various buttons for operations on the liquid crystal panel 1719. Images for the icons and the buttons are stored in the memory 1721. The touch sensor 1720 detects a user touching the display screen to transmit information about position touched by the user to the display control unit 1718. The display control unit 1718 detects a user's operation based on the output of the touch sensor 1720 and sends it to the control unit 1707. The control unit 1707 executes the processing described later according to the user's operation.

The charging apparatus 1700 has a function to transfer data between a plurality of charge target devices 300 placed on the charging apparatus 1700, by the user operating the display screen of the display unit 1717.

A communication unit 1713 performs wireless communication with the charge target devices 300 to obtain information such as image data and information used for wireless communication stored in the charge target devices 300. The control unit 1707 stores the obtained information in a memory 1722. When the one device is instructed to transmit data to the other device, the communication unit 1713 temporarily receives data from the device of transmission source and transmits the data to the device of transmission destination, as described below. The charging apparatus 1700 also has a certification and smoothing circuit 1705 to which an AC voltage is supplied from a power supply plug 1723, a data processing unit 1714, a signal processing unit 1715, an antenna 1716, similar to the charging apparatus 200.

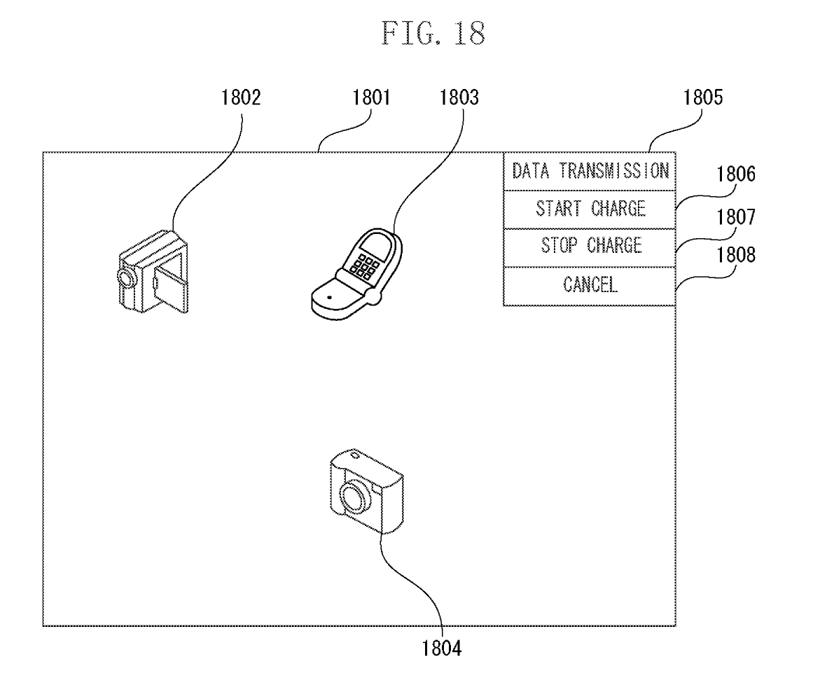

FIG. 18 illustrates a display screen of the display unit 1717. In the present exemplary embodiment, the power supply of the charging apparatus 1700 is turned on to automatically display a screen illustrated in FIG. 18 on the display unit 1717. As illustrated in FIG. 16, if the cellular phone 300A, the digital camera 300B, and the video camera 300C, for example, are placed on the charging units 1701A, 1702A, and 1704A of the charging apparatus 1700 respectively as the charge target device, the icons of the devices are displayed as illustrated in FIG. 18. In FIG. 18, the icons of the devices are displayed in positions corresponding to the areas of the charging units in the display screen of the charging apparatus 1700. If none of the charge target devices is placed on the charging apparatus 1700, the icon is not displayed. The screen illustrated in FIG. 18 may be displayed when a user's operation instructs the display unit 1717 to display the screen instead of automatically displaying the screen for communication control in FIG. 18.

In FIG. 18, a display screen 1801 displays icons 1802 to 1804 indicating the devices placed on the charging apparatus 1700. The display screen 1801 also displays a button 1805 for a data function, a button 1806 for instructing the start of charging, a button 1807 for instructing the stop of charge, and a cancel button 1808.

In the present exemplary embodiment, although data of the icons 1802 to 1804 are stored in the memory 1721, the data of the icons may be obtained from each device. As long as each device can be identified, other images may be displayed instead of the icons.

The user touches the display screen 1801 to instruct operation.

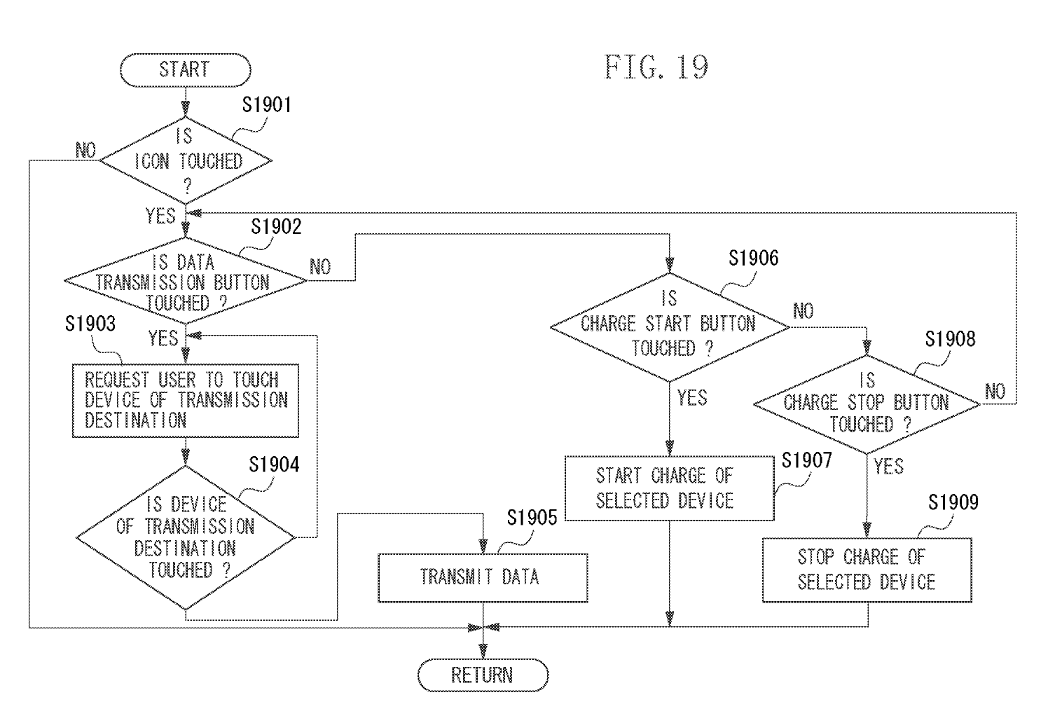

Processing related to user's operation in the present exemplary embodiment is described below using a flow chart in FIG. 19. The processing in FIG. 19 is executed by the control unit 1707 controlling each unit. As described above, when the devices placed on the charging units 1701A to 1704A are identified, the display screen 1801 is displayed on the display unit 1717 as illustrated in FIG. 18. Information used for data transfer is obtained from each device.

In this state, the user touches the icon of a device to be operated and then touches each function button to instruct the operation of the touched device. In step S1901, if the control unit 1707 determines that the icon of any of the devices is touched, the control unit 1707 subsequently determines whether the data transmission button 1805 is touched in step S1902. If the data transmission button 1805 is touched (YES in step S1902), in step S1903, information for requesting the user to touch the device of transmission destination is displayed on the display unit 1717. In this case, a table of data stored in the device of transmission source, i.e., in the device touched in step S1901 is displayed before the user is requested to touch the device of transmission destination and the user may select data to be transmitted from among the data.

In step S1904, if the icon of the device of transmission destination is touched, in step S1905, the communication unit 1713 reads data from the device of transmission destination and transmits the data to the device of transmission destination.

In step S1906, if the charge start button 1806 is touched, in step S1907, the charging unit on which the touched device is placed starts charging. In step S1908, if the charge stop button 1807 is touched, in step S1909, the charging unit on which the touched device is placed stops charging. In the present exemplary embodiment, the display screen is returned to the display screen 1801 by operating the cancel button 1808. At this point, data transfer processing and charge processing in execution may be stopped or continue to be executed.

Thus, the present exemplary embodiment not only identifies a device placed on each charging unit but displays the icon of a placed device and operational function buttons. Then, the user performs an operation to transmit data between the devices.

Similar to the above exemplary embodiments, the charge start button 1806 may not be displayed if charge is started as soon as the identification of a device is completed or a device being charged is selected. A charge target device may be requested to send information about a currently remaining battery capacity to display the battery capacity of the charge target device.

In the above exemplary embodiments, the charging apparatus is in a plate shape and a charge target device is placed thereon to enable non-contact charging.

In addition to the above configuration, other configuration may be adopted in which a charging apparatus is vertically arranged or each device is arranged in the vicinity of a charging unit by suspending each device, thereby charging in a non-contact manner. Also in this case, if there are charge target devices to which a plurality of charging units supplies electric power, each device is identified and the charge processing is controlled.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-018278 filed Jan. 29, 2009, which is hereby incorporated by reference herein in its entirety.

What is claimed is:

1. An apparatus comprising:
a plurality of power supplying units configured to supply electric power to external devices with a battery in a non-contact manner;
an acquisition unit configured to acquire information about a power receiving state, the information indicating whether the plurality of external devices receive electric power; and
an identification unit configured to identify an external device to which the plurality of power supplying units supply electric power based on the acquired information.

2. The apparatus according to claim 1, further comprising a detection unit configured to detect a power supplying unit which supplies the external device with electric power, among
the plurality of power supplying units, wherein, the identification unit identifies the external device.

3. The apparatus according to claim 1, further comprising a control unit configured to control whether or not the plurality of electric power supplying units supplies electric power, wherein,
the identification unit identifies the external device based on the information when the control unit causes the one of the plurality of power supplying units to supply electric power and the power supplying units except the one electric power supplying unit to stop supplying electric power.

4. The apparatus according to claim 1, further comprising a control unit configured to control whether or not the plurality of power supplying units supplies electric power, wherein,
the identification unit identifies the external device when the control unit causes the power supplying unit to supply electric power and the information when the control unit causes the power supplying unit to stop supplying electric power.

5. The apparatus according to claim 4, wherein,
the control unit switches in a predetermined pattern between a state where the plurality of power supplying units supply electric power to a power supply target device and a state where the plurality of power supplying units stop supplying electric power, and the acquisition unit acquires information about a power receiving state of another external device and identifies the external devices to which the plurality of electric power supplying units supply electric power based on the information according to switching operation of the control unit in the predetermined pattern.

6. The apparatus according to claim 1, further comprising a communication unit configured to communicate with the external device, wherein
the acquisition unit acquires the information about the power receiving state based on information received by the communication unit from the external device.

7. The apparatus according to claim 1, further comprising a plurality of communication units configured to communicate with the external device, wherein
the acquisition unit acquires the information about a charging state based on information received by the plurality of communication units from the external device.

8. The apparatus according to claim 1, wherein,
the acquisition unit acquires the information identified by the identification unit and includes a control unit configure to control an operation of the plurality of power supplying units based on the acquired information related to a charge processing.

9. The apparatus according to claim 1, wherein,
the external device includes a device which can perform communication and a control unit configured to cause two external devices selected from among the plurality of external devices identified by the identification unit to transmit data therebetween.

10. The apparatus according to claim 9, further comprising a selection unit configured to select a device of data transmission source and a device of data transmission destination from among the plurality of external devices identified by the identification unit.

11. The apparatus according to claim 1, further comprising a display unit configured to display information indicating the identified external device.

12. An apparatus for supplying electric power with a battery comprising:
a plurality of power supplying units configured to supply electric power to the external devices in a non-contact manner, wherein the plurality of power supplying units supply electric power to the external devices arranged in a plurality of predetermined areas corresponding to the plurality of power supplying units;
an identification unit configured to identify the external devices arranged in the plurality of predetermined areas;
a display unit configured to display information about the plurality of identified external devices; and
a control unit configured to control the plurality of identified external devices to transmit data between the plurality of identified external devices.

13. A method comprising:
supplying electric power to external devices with a battery in a non-contact manner by a plurality of power supplying units;
acquiring information about a power receiving state by an acquisition unit, the information indicating whether the plurality of external devices receive electric power; and
identifying an external device to which the plurality of power supplying units supply electric power based on the acquired information by an identification unit.

14. The method according to claim 13, further comprising detecting a power supplying unit, by a detection unit, which supplies the external device with electric power, among the plurality of power supplying units, wherein,
the identification unit identifies the external device.

15. The method according to claim 13, further comprising controlling, by a control unit, whether or not the plurality of electric power supplying units supplies electric power, wherein,
the identification unit identifies the external device based on the information when the control unit causes the one of the plurality of power supplying units to supply electric power and the power supplying units except the one electric power supplying unit to stop supplying electric power.

16. The method according to claim 13, further comprising controlling, by a control unit, whether or not the plurality of power supplying units supplies electric power, wherein,
the identification unit identifies the external device when the control unit causes the power supplying unit to supply electric power and the information when the control unit causes the power supplying unit to stop supplying electric power.

17. The method according to claim 16, further comprising:
switching, by the control unit, in a predetermined pattern between a state where the plurality of power supplying units supply electric power to a power supply target device and a state where the plurality of power supplying units stop supplying electric power;
acquiring, by the acquisition unit, information about a power receiving state of another external device and identifying the external devices to which the plurality of electric power supplying units supply electric power based on the information according to switching operation of the control unit in the predetermined pattern.

18. The method according to claim 13, further comprising communicating with the external device by a communication unit, wherein
the acquiring the information about the power receiving state is based on information received by the communication unit from the external device.

19. The method according to claim 13, further comprising communicating with the external device by a plurality of communication units, wherein
acquiring the information about a charging state is based on information received by the plurality of communication units from the external device.

20. The method according to claim 13, wherein,
the acquiring the information is identified by the identification unit and includes controlling, by a control unit, an operation of the plurality of power supplying units based on the acquired information related to a charge processing.
